(19) United States
(12) Patent Application Publication
(10) Pub. No.: US 2021/0047781 A1
(43) Pub. Date: Feb. 18, 2021

(54) LOTION TREATED TISSUE PRODUCT

(71) Applicant: Kimberly-Clark Worldwide, Inc., Neenah, WI (US)

(72) Inventors: Frederick John Lang, Neenah, WI (US); Devon Gaynelle Curley, Appleton, WI (US); Jessica Caroline Rogers, Appleton, WI (US); Kevin Joseph Vogt, Neenah, WI (US)

(21) Appl. No.: 16/966,934

(22) PCT Filed: Jun. 28, 2019
(86) PCT No.: PCT/US2019/039733

§ 371 Date: Aug. 3, 2020

Related U.S. Application Data
(60) Provisional application No. 62/691,005, filed on Jun. 28, 2018.

(51) Int. Cl. D21H 19/20; D21H 19/12; D21H 27/00; D21H 21/18; D21H 25/06; D21H 19/24

(52) U.S. Cl. CPC D21H 19/20; D21H 19/12; D21H 19/24; D21H 21/18; D21H 25/06; D21H 27/005

(57) ABSTRACT

Provided are tissue products and methods of producing the same comprising an aqueous softening composition consisting essentially of a polymeric polyhydroxy compound, a polysiloxane, a surfactant, glycerin and water. In certain instances the polymeric polyhydroxy compound may have a molecular weight of at least about 1,000 g/mol and the ratio of polymeric polyhydroxy compound to the polysiloxane, on a weight basis, is from about 10:1 to about 5:1. The lotion treated tissue products have both sufficient strength to withstand use, such as a geometric mean tensile (GMT) from about 700 to about 1,500 g/3″ and a smooth feel, such as a coefficient of friction less than about 300 g. These properties may be achieved despite applying less than about 5.0 dry weight percent (wt %), of the softening composition to the tissue product.

### BACKGROUND

Tissue products, and particularly bath and facial tissue products, are often used for wiping and cleaning of the body. When wiping frequently with such products certain users may experience irritation and inflammation. Often the irritation and inflammation are caused, in-part, by the tissue product having a relatively rough surface.

There have been numerous previous attempts to correct the problem of irritation and inflammation caused by wiping with tissue products. One common approach has been to provide tissue products having improved smoothness and/or softness. One means of producing such a product involves applying a chemical additive to the product's surface. For example, chemical debonders that interfere with the natural fiber-to-fiber bonding may be added to produce a softer, less harsh, product. Exemplary chemical debonding agents include quaternary ammonium salts such as trimethylcocoammonium chloride, trimethyloleylammonium chloride, dimethyldi(hydrogenated-tallow) ammonium methyl sulfate and trimethylstearylammonium chloride. Mono or diester variations of the aforementioned quaternary ammonium salts have also been taught for use in tissue products.

Others have attempted to produce a soft tissue product by applying lotions comprising one or more oils, such as mineral oil, waxes, such as paraffin, or plant extracts, such as chamomile and aloe vera, to the surface of the tissue product. For example, U.S. Pat. No. 5,525,345 teaches the use of a lotion composition comprising from about 20 to about 95 percent of a substantially water free emollient, such as mineral oil or petrolatum, and an immobilizing agent capable of forming hydrogen bonds with the cellulosic fibers, such as a polyhydroxy fatty acid ester. The immobilizing agent is needed to counteract the tendency of the emollient to migrate to the interior of the tissue, away from the surface where it may be brought into contact with a user's skin.

Still others, such as those disclosed in US Publication No. 2019/0078262A1, attempted to produce a soft, treated tissue by applying a softening composition comprising cationic softening compounds, such as alkyl quaternary ammonium compounds and imidazolinium compounds. Generally, such compositions required relatively high add-on levels to achieve the desired softness, which had a negative effect on other properties such as tensile strength and absorption.

Despite these efforts the problem of irritation and inflammation resulting from use of tissue products persists. Accordingly, it is an objective of the present invention to provide a tissue paper product which causes less irritation and inflammation to a user's skin. It is a further objective of this invention to provide a treated tissue paper product having a softening composition disposed thereon, where the tissue products have improved surface properties, such as a reduced coefficient of friction. It is yet a further objective of the present invention to provide an aqueous softening composition that may be easily and effectively applied to a tissue product using a wide variety of methods.

### SUMMARY

It has now been discovered that tissue softness, measured as coefficient of friction (COF) or using a tissue softness analyzer, such as an EMTEC Tissue Softness Analyzer (commercially available from Emtec Electronic GmbH, Leipzig, Germany), may be improved by treating the tissue with an aqueous softening composition that is substantially free from quaternary ammonium compounds Further, it has been discovered that the desired softness may be achieved at relatively low add-on levels, such as less than about 10 percent, by weight of the tissue web.

The quaternary ammonium compound free softening composition of the present invention is also well suited to a wide range of application methods such as, for example, contact printing methods such as gravure, offset gravure, flexographic printing, slot coating, blade coating, air knife coating, short dwell coating, and cast coating. Alternatively, the softening composition may be applied to a tissue web by non-contact printing methods such as ink jet printing and digital printing.

Accordingly, in one embodiment the present invention provides a softening composition, particularly a softening composition that is well suited for topical application to tissue webs and products, consisting essentially of a polymeric polyhydroxy compound, a polysiloxane, a surfactant, glycerin and water. The softening composition of the present invention may be topically applied to tissue webs or products to reduce COF. In other instances, the softening composition may be topically applied to provide the tissue web or product with a moisturizing feeling.

In another embodiment, the present invention provides an aqueous softening composition useful in the manufacture of tissue webs and products, the composition consisting essentially of from about 0.1 to about 5.0 weight percent (wt %) of silicone; from about 5 to about 20 wt % of a polymeric polyhydroxy compound having a molecular weight of at least about 1,000 g/mol; from about 2 to about 20 weight nonionic surfactant, from about 5 to about 20 wt % glycerin and from about 40 to about 80 wt % water. Generally, the foregoing aqueous softening composition is topically applied to a tissue web at add-on levels from about 0.5 to 5.0 dry wt % for improving softness and moisturizing feeling of the tissue web.

In other embodiments the present invention provides a tissue web comprising an aqueous softening composition consisting essentially of a polymeric polyhydroxy compound that is a solid at about 70° F. (21° C.), a polysiloxane, a surfactant, glycerin and water. In certain instances, the softening composition may comprise a polyhydroxy compound having a molecular weight of at least about 1,000 g/mol, such as from about 1,000 to about 5,000 g/mol. Other compositions may comprise two or more polymeric polyhydroxy compounds. For example, the composition may comprise a first polyethylene glycol having a molecular weight of about 300 g/mol and a second polyethylene glycol having a molecular weight of about 1,450 g/mol.

In still other embodiments, the present invention provides a lotion treated tissue that is both sufficiently strong to withstand use, such as having a geometric mean tensile (GMT) from about 700 to about 1,500 g/3″ and more preferably from about 800 to about 1,000 g/3″, and having a low coefficient of friction (COF), such as a COF less than about 300 g, and more preferably less than about 250 g and still more preferably less than about 200 g.

In other embodiments, the present invention provides a tissue product comprising at least one tissue web having an aqueous softening composition consisting essentially of a polymeric polyhydroxy compound having a molecular weight of at least about 1,000 g/mol, a polysiloxane, a surfactant, glycerin and water disposed thereon, the tissue product having a basis weight greater than about 25 grams per square meter (gsm), a GMT greater than about 700 g/3″ and a COF less than about 300 g, such as from about 175 to about 225 g.

In still other embodiments the invention provides a tissue product comprising at least one tissue web having a first surface and an opposed second surface, an aqueous softening composition disposed on at least the first surface, the aqueous softening composition consisting essentially of a polymeric polyhydroxy compound having a molecular weight of at least about 1,000 g/mol, a polysiloxane, a surfactant, glycerin and water.

In a particularly preferred embodiment the present invention provides a tissue comprising less than about 5.0 dry weight percent (wt %), and in certain embodiments less than about 2.5 dry wt %, such as from about 0.5 to about 2.5 dry wt % of the inventive softening composition. This discovery provides the flexibility to produce a tissue product with satisfactory softness at a given tensile strength while reducing the add-on of softening composition.

In other embodiments the present invention provides a tissue product produced by dispersing a furnish to form a fiber slurry; forming a wet tissue web; partially dewatering the wet tissue web; drying the partially dewatered web to yield a dried tissue web; and topically applying an aqueous softening composition to the dried tissue web, the aqueous softening composition consisting essentially of a polymeric polyhydroxy compound having a molecular weight of at least about 1,000 g/mol, a polysiloxane, a surfactant, glycerin and water at add on levels less than about 5.0 dry weight percent (wt %), by weight of the dried tissue web.

### Definitions

As used herein the term “add-on” refers to the amount of softening composition, on a dry weight basis, added to the tissue web or product. Add-on may be calculated by determining the dry weight of the softening composition added to the web or product and dividing by the bone dry basis weight of the web or product. For example, if 5.0 grams of softening composition comprising 40 percent solids is added to a tissue web having a bone dry basis weight of 40 gsm, the add-on is 5.0 percent.

As used herein the term “emulsion” refers to a heterogeneous mixture of a generally insoluble liquid comprising an aqueous phase and an organic phase.

As used herein, the term “basis weight” generally refers to the bone dry weight per unit area of a tissue and is generally expressed as grams per square meter (gsm). Basis weight is measured using TAPPI test method T-220. Normally, the basis weight of a tissue product of the present invention is less than about 80 grams per square meter (gsm), alternatively less than about 60 gsm, such as from about 10 to about 60 gsm and more preferably from about 20 to about 50 gsm.

As used herein, the term “caliper” is the representative thickness of a single sheet (caliper of tissue products comprising two or more plies is the thickness of a single sheet of tissue product comprising all plies) measured in accordance with TAPPI test method T402 using a ProGage 500 Thickness Tester (Thwing-Albert Instrument Company, West Berlin, N.J.). The micrometer has an anvil diameter of 2.22 inches (56.4 mm) and an anvil pressure of 132 grams per square inch (per 6.45 square centimeters) (2.0 kPa).

As used herein, the term “Coefficient of Friction” (COF) refers to the root mean square of the machine direction (MD) and cross-machine direction (CD) COF measured as described in the Test Methods section below. While the COF may vary depending on the tissue web to be treated, the composition of the softener and the add-on amount, tissue products and webs produced as described herein may have a COF less than about 300 g, such as less than about 250 g, such as less than about 200 g. In certain instances, tissue products prepared according to the present invention may have a COF from about 100 to about 300 g, such as from about 150 to about 250 g, such as from about from about 175 to about 225 g.

As used herein, the term “sheet bulk” refers to the quotient of the sheet caliper (generally having units of μm) divided by the bone dry basis weight (generally having units of grams per square meter). The resulting sheet bulk is expressed in cubic centimeters per gram (cc/g). While the sheet bulk of the products prepared according to the present invention may vary depending on the method of manufacture, the tissue products generally have a sheet bulk greater than about 10.0 cc/g such as from about 10.0 to about 20.0 cc/g and more preferably from about 12.0 to about 15.0 cc/g.

The term “ply” refers to a discrete product element. Individual plies may be arranged in juxtaposition to each other. The term may refer to a plurality of web-like components such as in a multi-ply facial tissue, bath tissue, paper towel, wipe, or napkin.

As used herein, the term “slope” refers to slope of the line resulting from plotting tensile versus stretch and is an output of the MTS TestWorks™ in the course of determining the tensile strength as described in the Test Methods section herein. Slope is reported in the units of mass per unit of sample width and is measured as the slope of the least-squares line fitted to the load-corrected strain points falling between a specimen-generated force of 70 to 157 grams (0.687 to 1.540 N) divided by the specimen width. Slopes are generally reported herein as having units of grams force (gf) or kilograms force (kgf).

As used herein, the term “geometric mean slope” (GM Slope) generally refers to the square root of the product of machine direction slope and cross-machine direction slope. GM Slope generally is expressed in units of kilograms (kg).

As used herein, the term “geometric mean tensile” (GMT) refers to the square root of the product of the machine direction tensile strength and the cross-machine direction tensile strength of the web. While the GMT may vary, tissue products prepared according to the present disclosure generally have a GMT greater than about 500 g/3″, such as from about 500 to about 1,500 g/3″ and more preferably from about 750 to about 1,000 g/3″.

As used herein, the term “Stiffness Index” refers to the quotient of the geometric mean tensile slope, defined as the square root of the product of the MD and CD slopes (typically having units of kgf), divided by the geometric mean tensile strength (typically having units of gf).

$$Stiffness Index = \frac{\sqrt{MD Tensile Slope ( kgf ) \times CD Tensile Slope ( kgf )}}{GMT ( gf )} \times 1 , 000$$

While the Stiffness Index may vary, tissue products prepared according to the present disclosure generally have a Stiffness Index less than about 20 and more preferably less than about 15, such as from about 10 to about 20 and more preferably from about 10 to about 15.

As used herein, the terms “T57” and “TS7 value” refer to the output of the EMTEC Tissue Softness Analyzer (commercially available from EMTEC Electronic GmbH, Leipzig, Germany) as described in the Test Methods section. TS7 has units of dB V2 rms, however, TS7 may be referred to herein without reference to units. The TS7 value is the frequency peak that occurs around 6.5 kHz on the noise spectrum graph output from the EMTEC Tissue Softness Analyzer. This peak represents the softness of the sample. Generally, softer samples produce a lower TS7 peak. In certain embodiments the invention provides a tissue product, such as a through-air dried tissue product, having a TS7 less than about 11.0 and more preferably less than about 10.5, such as from about 8.0 to about 11.0. The foregoing TS7 values are generally achieved at geometric mean tensile strengths from about 500 to about 1,500 g/3″.

As used herein, a “tissue product” generally refers to various paper products, such as facial tissue, bath tissue, paper towels, napkins, and the like. Tissue products may comprise one, two, three or more plies. The tissue product may be a web of tissue spirally wound onto a core or may comprise individual folded sheets that may be stacked together.

The term “dry tissue web” as used herein includes both webs which are dried to a moisture content less than the equilibrium moisture content thereof and webs which are at a moisture content in equilibrium with atmospheric moisture.

As used herein, “weight percent,” “percent by weight” (wt %) in reference to a named compound or material means the amount of the respective named compound or material, exclusive, for example, of any associated solvent, relative to a mixture or composition that contains the compound or material, expressed as a percent of the total weight of such mixture or composition.

### DETAILED DESCRIPTION

It has now been surprisingly discovered that a softening composition that is substantially free from quaternary ammonium compounds including, for example, amidoamine quaternary ammonium compounds, diamidoamine quaternary ammonium compounds, ester quaternary ammonium compounds, alkoxy alkyl quaternary ammonium compounds, benzyl quaternary ammonium compounds, alkyl quaternary ammonium compounds, and imidazolinium compounds, may be used to produce tissue products having good tactile properties without negatively affecting other important tissue product properties such as tensile strength and absorption.

Accordingly, in a preferred embodiment the invention provides a softening composition consisting essentially of a polymeric polyhydroxy compound having a molecular weight of at least about 1,000 g/mol, a polysiloxane, a surfactant, glycerin and water.

Despite being substantially free from amidoamine quaternary ammonium compounds, diamidoamine quaternary ammonium compounds, ester quaternary ammonium compounds, alkoxy alkyl quaternary ammonium compounds, benzyl quaternary ammonium compounds, alkyl quaternary ammonium compounds, and imidazolinium compounds the softening composition demonstrates good retention on the surface of the tissue product and is capable of providing good tactile properties, such as a relatively low coefficient of friction (COF), such as a COF less than about 300 gf and more preferably less than about 250 gf, and still more preferably less than about 225 g. In certain instances, the inventive tissue products may have a COF from about 100 to about 300 g, more preferably from about 150 to about 250 g and still more preferably from about 175 to about 225 g.

In other instances, the high degree of softening provided by the inventive softening composition may be measured using a tissue softness analyzer, such as an EMTEC Tissue Softness Analyzer (commercially available from Emtec Electronic GmbH, Leipzig, Germany). Accordingly, in certain embodiments the invention provides a tissue product, particularly a through-air dried tissue product, comprising a softening composition consisting essentially of a polymeric polyhydroxy compound having a molecular weight of at least about 1,000 g/mol, a polysiloxane, a surfactant, glycerin and water, wherein the tissue has a TS7 less than about 11.0 and more preferably less than about 10.5, such as from about 8.0 to about 11.0. The foregoing TS7 values are generally achieved at geometric mean tensile strengths from about 500 to about 1,500 g/3″.

The satisfactory level of softness on at least one surface of the tissue web may be achieved by applying relatively low levels of the aqueous softening composition to the surface of the tissue web, such as less than about 5.0 dry weight percent (wt %), by weight of the dry tissue web, and more preferably less than about 2.5 dry wt % and still more preferably less than about 1.0 dry wt %. In certain instances, the total softening composition add-on may range from about 0.25 to about 5.0 dry wt %, such as from about 0.5 to about 3.0 dry wt % and more preferably from about 0.5 to about 2.5 dry wt %.

Accordingly, in certain preferred embodiments the softening composition may be applied to a tissue substrate at relatively low add-on levels, such as less than 5.0 dry weight percent (wt %) and more preferably less than about 2.5 dry wt % and still provide the treated tissue with a relatively low coefficient of friction (COF), such as a COF less than about 300 gf and more preferably less than about 250 gf.

In other embodiments the softening composition may be applied to a tissue substrate at relatively low add-on levels, such as less than 5.0 dry weight percent (wt %) and more preferably less than about 2.5 dry wt % and achieve relatively low coefficient of friction, such as less than about 300 g, and a low TS7 value, such as a TS7 less than 11.0. The foregoing treated tissue product may retain a relatively high degree of strength, such as a GMT greater than about 500 g/3″, such as from about 500 to about 1,500 g/3″, more preferably from about 700 to about 1,100 g/3″ and more preferably from about 800 to about 1,000 g/3″.

The softening composition of the present invention, which is preferably an aqueous softening composition substantially free from quaternary ammonium compounds, generally comprises a polymeric polyhydroxy compound and more preferably a relatively high molecule weight polymeric polyhydroxy compound, such as a polymeric polyhydroxy compound having a molecular weight of at least about 1,000 g/mol, such as at least about 2,000 g/mol, such as at least about 3,000 g/mol, such as at least about 4,000 g/mol. For example, the molecule weight of polymeric polyhydroxy compound may range from about 1,000 to about 12,000 g/mol, such as from about 1,500 to about 10,000 g/mol, such as from 4,000 to 10,000 g/mol, such as from about 6,000 to about 8,000 g/mol.

Examples of polymeric polyhydroxy compounds useful in the present invention include, but are not limited to, polyethylene glycols and polypropylene glycols having a molecular weight of at least about 1,000 g/mol and more preferably at least about 2,000 g/mol and still more preferably at least about 4,000 g/mol, such as from about 1,000 to about 12,000 g/mol, and more preferably from about 4,000 to about 10,000 g/mol and still more preferably from about 6,000 to about 8,000 g/mol.

While a single polymeric polyhydroxy compound may be useful in formulating the softening composition, in other instances the softening composition may comprise two or more different polymeric polyhydroxy compounds, such as polyethylene glycol of different molecular weights. Thus, in one embodiment the softening composition may comprise a first polyethylene glycol having a first molecular weight and a second polyethylene glycol having a second molecular weight, such as a first polyethylene glycol having a molecular weight from about 1,000 to about 6,000 g/mol and a second polyethylene glycol having a molecular weight from about 8,000 to about 10,000 g/mol.

In certain instances, it may be preferable that the polymeric polyhydroxy compound be a solid at room temperature. For example, the polymeric polyhydroxy compound may be a polyethylene glycol having a molecular weight from 1,000 to about 6,000 g/mol. Alternatively, the polymeric polyhydroxy compound may be a blend of two or more polyethylene glycols, where the blend is a solid at room temperature, such as a blend of first polyethylene glycol having a molecular weight of about 300 and a second polyethylene glycol having a molecular weight of about 1,450.

The polymeric polyhydroxy compound may be incorporated in the softening composition of the present invention in varying amounts. For example, the softening composition comprises at least about 5.0 wt % of the polymeric polyhydroxy compound, such as from about 5.0 to about 30 wt %, such as from about 5.0 to about 20 wt %.

To further enhance softening of the treated tissue, the softening composition may also include a polysiloxane, also referred to herein as a silicone or as a siloxane. A large variety of silicones are available that are capable of enhancing the tactile properties of the finished tissue sheet. Any silicone capable of enhancing the tactile softness of the tissue sheet is suitable for incorporation in this manner.

Examples of suitable silicones include, but are not limited to, linear polydiallyl polysiloxanes such as the DC-200 fluid series available from Dow Corning, Inc., Midland, Mich., as well as the organo-reactive polydimethyl siloxanes such as the preferred amino functional polydimethyl siloxanes. Examples of suitable silicones include those described in U.S. Pat. Nos. 6,054,020 and 6,432,270, the disclosures of which are incorporated herein by reference in a manner consistent with the instant disclosure. Suitable silicones generally have the formula:

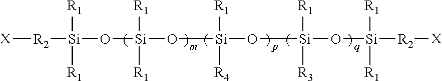

wherein:

X is a hydrogen, hydroxy, amino, C₁₋₈ straight chain, branched, cyclic, unsubstituted or hydrophilically substituted alkyl or alkoxyl radical;

m=20-100,000;

p=1-5000;

q=0-5000;

R₁=a C₁₋₆, straight chain, branched or cyclic alkyl radical;

R₂=a C₁₋₁₀ straight chain or branched, substituted or unsubstituted alkylene diradical;

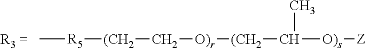

wherein:

R₅ is an unsubstituted or a hydrophilically substituted C₁₋₁₀ alkylene diradical;

r=1-10,000;

s=0-10,000; and

Z=hydrogen, C₁₋₂₄ alkyl group, or a G-group, where G is selected from the following: —R₆COOR₇; —CONR₈R₉; —SO₃R₈; and PO R₈R₉, where R₆ is a substituted or unsubstituted C₁₋₆ alkylene diradical; R₇, R₈, and R₉ are independently a hydrogen radical or a substituted or unsubstituted C₁₋₈ alkyl radical; and

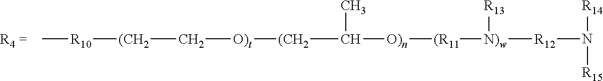

wherein:

R₁₀, R₁₁, and Rig are independently an unsubstituted or a hydrophilically substituted C₁₋₈ alkylene diradical;

t=0-10,000;

u=0-10,000;

w=0-10,000; and

R₁₃, R₁₄ and R₁₅ are independently a hydrogen radical, an unsubstituted or a hydroxyl, carboxyl or other functionally substituted C₁₋₁₀ straight chain, branched, or cyclic alkyl radical.

When incorporated in the softening composition, silicone may be added at varying amounts. For example, the softening composition comprises at least about 1.0 wt % silicone, such as from about 1.0 to about 10.0 wt %, and more preferably from about 2.0 to about 5.0 wt %.

The relative ratio of the polymeric polyhydroxy compound to the silicone may be varied to achieve the desired tissue product properties or to accommodate different methods of application. For example, the weight ratio (on a dry weight basis) of the polymeric polyhydroxy compound to the silicone ranges from about 15:1 to about 1:1 and more preferably from about 10:1 to about 5:1. The foregoing ratios are merely representative of certain preferred softening compositions and should not be construed as limiting and may vary depending upon the molecular weight of the particular silicone and polymeric polyhydroxy compound used.

In addition to silicone and a polymeric polyhydroxy compound, the softening composition consists of glycerin. The amount of glycerin included in the softening composition may range from about 1.0 to about 30 wt %, such as from about 2.0 to about 25 wt %, and still more preferably from about 5.0 to about 20 wt %.

In particularly preferred embodiments the softening composition of the present invention comprises a surfactant. The surfactant may be included in the softening composition to facilitate emulsification of one or more components of the composition, such as the polymeric polyhydroxy compound or the polysiloxane or to enhance the softness and wettability of the treated tissue.

Surfactants which are preferred for use in the present invention are noncationic and, more preferably, are nonionic. Preferred surfactants include, but are not limited to, polyoxyethylene alkylamines, trialkylamine oxides, triethanol amine fatty acid esters and partial fatty acid esters, polyoxyethylene alkyl ethers such as those obtained by ethoxylation of long chain alcohols, polyoxyethylene alkenyl ethers, alkylphenyl ethoxylates, polyoxyethylene polystyriphenyl ethers, polypropylene glycol fatty acid esters and alkyl ethers, polyethylene glycol fatty acid esters and alkyl ethers, polyhydric alcohol fatty acid partial esters and alkyl ethers, glycerin fatty acid esters, polyglycerin fatty acid esters, polyoxyethylene polyhydric alcohol fatty acid partial esters and alkyl ethers, polyoxyethylene sorbitan fatty acid esters, polyoxyethylene glycerin fatty acid esters, polyoxyethylene fatty acid esters and alkyl ethers, polyglycerin fatty acid esters, ethoxylated/propoxylated vegetable oils, and the like, including mixtures of said surfactants.

In certain instances, the surfactant may be alkylphenoxy polyethoxy ethanols available from Union Carbide Corporation under the trade name TRITON®; trimethylnonyl polyethylene glycol ethers and polyethylene glycol ethers of 11-15 carbon atom containing alcohols, which may be linear or branched, preferably branched, available from Union Carbide Corporation under the trade name TERGITOL®; and the nonionic ethoxylated tridecyl ethers, available from Emery Industries under the trade name TRYCOL®.

The amount of surfactant in the softening composition may range from about 0.5 to 20 wt %, such as from 1.0 to 15 wt %, more preferably from 2.0 to 15 wt % and still more preferably from about 4.0 to 10 wt %. In certain instances, the softening composition consists of a nonionic surfactant which is present in an amount ranging from about 4.0 to 10 wt %.

In certain preferred embodiments the softening composition of the present invention may be provided as an aqueous emulsion, and more preferably as an aqueous emulsion that does not require further heating prior to use. Thus, the softening composition may be prepared and applied to the tissue as an emulsion comprising at least about 40 wt % water (as a percent of the total weight of the emulsion), such as from about 40 to about 90 wt % water, such as from about 45 to about 80 wt % water.

In particularly preferred embodiments, particularly in those instances where the softening composition is applied by a contact printing process, such as gravure printing, the softening composition may comprise from about 40 to about 90 wt % water, such as from about 45 to about 80 wt % water.

In those instances where the softening composition is applied to the tissue as an aqueous emulsion the tissue may dry or be dried to evaporate the water from the tissue surface leaving the polymeric polyhydroxy compound and the silicone to soften the tissue.

In certain instances, the amount of water in the softening composition may be varied depending upon the amount of the polymeric polyhydroxy compound. For example, the mass ratio of water to the polymeric polyhydroxy compound may range from about 15:1 to about 2:1, such as from about 12:1 to about 5:1. In certain instances water comprises from about 40 to about 80 wt %, by weight of the softening composition, and the polymeric polyhydroxy compound comprises from about 5.0 to about 20 wt % by weight of the softening composition.

One advantage of the present softening composition is that it may not be necessary to heat the composition prior to applying it to the tissue web. Accordingly, the application of the softening composition to the web may occur at ambient temperatures, such as less than about 30° C., such as from about 15 to about 30° C. and more preferably from about 20 to about 25° C.

While it may not be necessary to heat the softening composition prior to application, preparation of the emulsion may require heating of one or more of the components. For example, the emulsion may be prepared by heating the polymeric polyhydroxy compound to a temperature greater than about 50° C., such as from about 50 to about 70° C., and then adding the silicone and mixing, followed by the addition of water and further mixing to form the emulsion. Upon mixing, the emulsion generally has a viscosity less than about 200 cPs, such as from about 10 to about 200 cPs and more preferably from about 20 to about 100 cPs.

Other chemical additives may optionally be added to the softening composition described herein so long as they do not significantly affect important tissue product properties, such as strength, absorbency or softness. Importantly these additional chemical additives do not affect the coefficient of friction of the tissue product. Optional additives may include opacifying agents, pH modifiers, dyes, fragrances, preservatives, humectants and skin protectants. Suitable humectants include lactic acid and its salts, sugars, hydrolyzed starch hydrolysate, urea, and sorbitol. Suitable skin protectants include allantoin, kaolin, zinc oxide, aloe vera, vitamin E, petrolatum, and lanolin. Again, the foregoing additives are generally complementary to the softening compositions of the present invention and generally do not significantly affect important tissue product properties, such as strength, absorbency or softness (measured as COF or TS7 as described herein).

In certain embodiments the softening composition may optionally include preservatives, which can act to inhibit bacterial or fungal growth. Examples of useful preservatives that may be included in the softening composition consist of potassium sorbate, sodium benzoate, benzyl alcohol, dehydroxyacetic acid, phenoxyethanol, parabens, methylchlorothiazolinone, methylisothiazolinone, and carbamates (including iodine derivatives such as iodopropynyl butylcarbamate).

A preservative is not essential. When a preservative is included it may be added to the extent required, depending on the environment in which the formulation is to be stored and/or used. When present, the softening composition may include preservatives in an amount of from 0.05 to 5 wt %, such as from 0.05 to 2 wt %.

In other instances, the softening composition may optionally include a water-soluble or water-dispersible rheology modifying agent. This will therefore be present in the aqueous phase of the formulation. The agent may suitably be a polymer, which may be natural or synthetic. Examples of natural polymers include xanthan gum, guar gums, modified guars, pectin, gum arabic, carageenan, alginates, and modified cellulose (e.g. carboxymethylated or hydroxypropyl cellulose). Synthetic polymers include polyacrylates and hydrophobically modified polyacrylates.

A rheology modifying agent is not essential. When a rheology modifying agent is included it is preferably included in the softening composition in an amount of from 0.05 to 3 wt %, such as from 0.05 to 2 wt %, preferably from 0.1 to 1 wt %.

In view of the foregoing, in certain instances the softening composition may consist essentially of 0.1 to about 5.0 wt % of a silicone; from about 5 to about 20 wt % of a polymeric polyhydroxy compound or mixtures thereof, from about 2 to about 20 wt % of a nonionic surfactant, from about 5 to about 20 wt % glycerin and from about 40 to about 80 wt % water. The softening composition may optionally include one or more additives selected from opacifying agents, pH modifiers, dyes, fragrances, preservatives, humectants and skin protectants.

The softening composition of the present invention may be added to the tissue web at any point after the web has been formed and at least partially dewatered. Preferably the softening composition is applied to the web after it has been dried to final dryness, such as a moisture content less than about 6.0 percent (by weight of the tissue web) and more preferably less than about 5.0 percent. For example, the softening composition may be applied after the drying section of the tissue machine where the tissue sheet has a consistency of from about 90 to about 100 percent. The softening composition may also be applied via a secondary post treatment process where the tissue sheet has a consistency of from about 90 to about 100 percent.

The method by which the softening composition is applied to the tissue sheet may be accomplished by any method known in the art. For example, the composition may be applied by contact printing methods such as gravure, offset gravure, flexographic printing, slot coating, blade coating, air knife coating, short dwell coating, cast coating, and the like. The contact printing methods often enable topical application of the composition to the tissue sheet. Alternatively, the softening composition may be applied to the tissue web by non-contact printing methods such as ink jet printing, digital printing of any kind, and the like.

One preferred method of applying the softening composition to the tissue web is by spraying the composition onto the web. For example, spray nozzles may be mounted over a moving tissue sheet to apply a desired dose of an emulsion according to the present invention to the tissue sheet. Nebulizers may also be used to apply a light mist to a surface of a tissue sheet. In other embodiments the softening composition may be applied to a moving belt or fabric by spray or other means and the belt or fabric may in-turn contact the tissue sheet to apply the softening composition to the tissue web. Alternatively, a WEKO fluid application system (commercially available from Weitmann & Konrad GmbH & Co., Leinfelden-Echterdingen, Germany), may be used to apply the softening composition to the web.

Other preferred methods of application include contact methods such as gravure printing, flexographic printing, spraying and topical application. A particularly preferred method of contact application is rotogravure printing such as described in U.S. Pat. No. 5,665,426, the contents of which are incorporated herein by reference in a manner consistent with the present disclosure.

In one embodiment the softening composition may be applied by a process where the softening composition is applied to the web via a transfer/applicator roll. For example, the softening composition may be applied to a transfer/applicator roll using a Mayer rod and then subsequently disposed on the web.

The softening composition may be applied to only a single surface of the tissue web or may be applied to both the upper and opposed lower surfaces of the web. The add-on amount of the softening composition on each surface of the tissue web is generally less than about 5.0 dry weight percent (wt %), by weight of the dry tissue web, and more preferably less than about 3.0 dry wt % and still more preferably less than about 2.5 dry wt % and still more preferably less than about 2.0 dry wt %. For example, the total softening composition add-on may range from about 0.25 to about 5.0 dry wt %, such as from about 0.5 to about 5.0 dry wt % and more preferably from about 0.5 to about 2.5 dry wt %.

When applied to the tissue web, the softening composition can cover the entire surface area of the web or a portion of the web. For example, the composition can be applied so as to cover from about 20 to about 80 percent of the surface area of the web, and particularly from about 30 to about 60 percent of the surface area of the web. In certain instances, depending on the composition of the softening composition, leaving untreated areas on the web, the web remains easily wettable, which can be a concern when applying hydrophobic additives.

Further, it is generally desirable after formation and drying of the web to prevent significant rewetting of the tissue sheet or to negatively affect the web's tensile strength by topically applying excessive amounts of the aqueous emulsion of the present invention. Preferably the add-on amount of softening composition on one surface is less than about 5.0 dry wt % and the addition of the softening composition results in a geometric mean tensile strength decrease of less than about 30 percent, as measured in the treated tissue sheet compared to the untreated tissue sheet. While having minimal negative effect on tensile strength the foregoing add-ons may reduce the coefficient of friction of an untreated tissue web by more than 20 percent, and in some instances by more than 25 percent, such as from about 20 to about 35 percent.

The reduction in COF may also be accompanied by improvements in other tissue product properties, such as the Stiffness Index. As such, in certain embodiments, tissue products prepared according to the present invention may have a GMT from about 700 to about 1,500 g/3″ and more preferably from about 750 to about 1,000 g/3″, a COF less than about 300 g and more preferably less than about 250 g, and still more preferably less than about 225 g, and a Stiffness Index less than about 10.0, such as from about 5.00 to about 10.0 and more preferably from about 5.00 to about 8.00. The foregoing tissue products may be prepared despite adding less than about 5.0 dry wt %, and in some instances less than about 2.0 dry wt %, of softening composition.

The softening composition of the present invention is useful in the manufacture of a wide variety of different tissue products. For most applications, however, the present invention is directed to applying the softening composition to tissue products, particularly wiping products. Such products include, for example, facial tissues and bath tissues that have a basis weight of less than about 100 gsm, and particularly from about 15 to about 60 gsm, and more particularly from about 25 to about 45 gsm. The tissue web can be made exclusively of pulp fibers or, alternatively, can contain pulp fibers mixed with other fibers.

Besides bath and facial tissue products, however, the softening composition of the present invention can also be applied to paper towels and industrial wipers. Such products can have a basis weight of up to about 200 gsm and particularly up to about 150 gsm. Such products can be made from pulp fibers alone or in combination with other fibers, such as synthetic fibers. The pulp fibers can be softwood fibers, hardwood fibers, thermomechanical pulp, and the like.

The paper web treated in accordance with the present invention can also be formed by a variety of processes, including wet pressed and through-air drying processes known in the art. For example, the paper web treated in accordance with the present invention can be conventional wet pressed, such as described in U.S. Pat. No. 9,896,805 or modified conventional wet pressed such as described in U.S. Pat. No. 6,921,460. In other instances, the web to be treated may be manufactured by a through-air dried process such as, creped through-air dried (CTAD), uncreped through-air dried (UCTAD), and the like. Examples of paper webs that can be used in the present invention include those disclosed in U.S. Pat. Nos. 5,048,589, 5,399,412 and 5,129,988.

While the type of tissue web treated according to the present invention may vary, in one instance the web is preferably an uncreped through-air dried web. Uncreped through-air dried webs are generally formed in a wet paper making process in which a slurry of fibers is deposited onto a forming fabric. To dry the formed web, the web is fed through a through-air dryer while the web is being supported by a dryer fabric. Once formed, the web can have a fabric side that is generally softer to the touch than the opposite side of the web. In one embodiment of the present invention, a composition is applied opposite the fabric side and then transferred to the fabric side when wound into a roll. When applying, for instance, softeners to paper webs, less composition is generally needed on the fabric side.

### Test Methods

### Basis Weight

The basis weight was measured as bone dry basis weight. Basis weight of the tissue sheet specimens may be determined using the TAPPI T410 procedure or a modified equivalent such as: Tissue samples are conditioned at 23±1° C. and 50±2 percent relative humidity for a minimum of 4 hours. After conditioning, a stack of 16 3-inch by 3-inch samples are cut using a die press and associated die. This represents a tissue sheet sample area of 144 in² or 929 cm². Examples of suitable die presses are TMI DGD die press manufactured by Testing Machines, Inc., Islandia, N.Y., or a Swing Beam testing machine manufactured by USM Corporation, Wilmington, Mass. Die size tolerances are ±0.008 inches in both directions. The specimen stack is then weighed to the nearest 0.001 gram using an analytical balance. The basis weight in grams per square meter (gsm) is calculated using the following equation: Basis weight=stack weight in grams/0.0929.

### Tensile

Samples for tensile strength testing are prepared by cutting a 3-inch (76.2 mm) by 3-inch (76.2 mm) long strip in either the machine direction (MD) or cross-machine direction (CD) orientation using a JDC Precision Sample Cutter (Thwing-Albert Instrument Company, Philadelphia, Pa., Model No. JDC 3-10, Ser. No. 37333). The instrument used for measuring tensile strengths is an MTS Systems Sintech 11S, Serial No. 6233. The data acquisition software is MTS TestWorks™ for Windows Ver. 4 (MTS Systems Corp., Research Triangle Park, N.C.). The load cell is selected from either a 50 Newton or 100 Newton maximum, depending on the strength of the sample being tested, such that the majority of peak load values fall between 10 and 90 percent of the load cell's full-scale value. The gauge length between jaws is 2±0.02 inches. The jaws are operated using pneumatic-action and are rubber coated. The minimum grip face width is 3 inches (76.2 mm), and the approximate height of a jaw is 0.5 inches (12.7 mm). The crosshead speed is 10±0.4 inches/min (254±1 mm/min), and the break sensitivity is set at 65 percent. The sample is placed in the jaws of the instrument, centered both vertically and horizontally. The test is then started and ends when the specimen breaks. The peak load is recorded as either the “MD tensile strength” or the “CD tensile strength” of the specimen depending on the sample being tested. The tensile energy absorption (TEA) at break (grams-force*cm/cm², calculated by integrating or taking the area under the stress-strain curve up to 70% of sample failure). At least six (6) representative specimens are tested for each product, taken “as is,” and the arithmetic average of all individual specimen tests is either the MD or CD tensile strength for the product.

### Coefficient of Friction

Coefficient of friction (“COF”) was determined using an MTS Systems Sintech 11S, Serial No. 6233. The data acquisition software is MTS TestWorks™ for Windows Ver. 4 (MTS Systems Corp., Research Triangle Park, N.C.). Samples are prepared by cutting a 3-inch (76.2 mm) by 5-inch (127 mm) long strip in the machine direction (MD) using a JDC Precision Sample Cutter (Thwing-Albert Instrument Company, Philadelphia, Pa., Model No. JDC 3-10, Ser. No. 37333). Samples were conditioned at 23±1° C. and 50±2 percent relative humidity for a minimum of 4 hours prior to testing.

The MD coefficient of friction was analyzed by placing three cut sheets of the basesheet material or finished tissue, treated side up, on the testing bed. The sample was secured to the testing bed by a clasp or double-sided tape. A single sheet of corresponding basesheet material or finished tissue specimen is attached to the COF testing sled with the treated side in facing arrangement with the treated side of the sample on the test bed. The samples were aligned with one another in the MD. Once the samples are affixed and arranged the test protocol is initiated to advance the sled. All COF units are in grams. Specific test parameters were as follows—Sled size: 1.5″×1.5″; Sled weight: 200±5 g; Sled Speed: 45 inches/min. Sliding Distance: 4″; Area of Measurement: 2″ to 3.5″; Data acquisition rate: 20 Hz. The static coefficient of friction, also referred to as the peak load force, output by the data acquisition software is reported as the COF and typically has units of grams force (gf) or simply grams (g).

### Tissue Softness

Tissue softness was measured using an EMTEC Tissue Softness Analyzer (“TSA”) (EMTEC Electronic GmbH, Leipzig, Germany). The TSA comprises a rotor with vertical blades which rotate on the test piece applying a defined contact pressure. Contact between the vertical blades and the test piece creates vibrations, which are sensed by a vibration sensor. The sensor then transmits a signal to a PC for processing and display. The signal is displayed as a frequency spectrum. For measurement of TS7 values the blades are pressed against the sample with a load of 100 mN and the rotational speed of the blades is two revolutions per second.

The frequency analysis in the range of approximately 200 to 1,000 Hz represents the surface smoothness or texture of the test piece. The peak in the frequency range between 200 to 1,000 Hz is herein referred to as the TS750 value and is expressed as dB V2 rms. A high amplitude peak correlates to a rougher surface.

A further peak in the frequency range between 6 and 7 kHz represents the softness of the test piece. The peak in the frequency range between 6 and 7 kHz is herein referred to as the TS7 value and is expressed as dB V2 rms. The lower the amplitude of the peak occurring between 6 and 7 kHz, the softer the test piece.

In addition to TS750 and TS7, the analyzer reports a stiffness parameter (D) having units of mm/N. The stiffness parameter (D) is the deformation of the sample under a defined load.

Test samples were prepared by cutting a circular sample having a diameter of 112.8 mm. All samples were allowed to equilibrate at TAPPI standard temperature and humidity conditions for at least 24 hours prior to completing the TSA testing. Only one ply of tissue is tested. Multi-ply samples are separated into individual plies for testing. The sample is placed in the TSA with the softer (air contacting side in the case of uncreped samples or the dryer or Yankee contacting side in the case of creped samples) side of the sample facing upward. The sample is secured, and the measurements are started via the PC. The PC records, processes and stores all the data according to standard TSA protocol. The reported values are the average of five replicates, each one with a new sample.

### Examples

Base sheets were made using a through-air dried papermaking process commonly referred to as “uncreped through-air dried” (“UCTAD”) and generally described in U.S. Pat. No. 5,607,551, the contents of which are incorporated herein in a manner consistent with the present invention. Base sheets with a target bone dry basis weight of about 46 grams per square meter (gsm) were produced.

In all cases the base sheets were produced from a furnish comprising northern softwood kraft and eucalyptus kraft using a layered headbox fed by three stock chests such that the webs having three layers (two outer layers and a middle layer) were formed. The two outer layers comprised eucalyptus (each layer comprising 30 percent weight by total weight of the web) and the middle layer comprised softwood and eucalyptus. The amount of softwood and eucalyptus kraft in the middle layer was maintained for all inventive samples—the middle layered comprised 29 percent (by total weight of the web) softwood and 11 percent (by total weight of the web) eucalyptus. Strength was controlled via the addition of starch and/or by refining the furnish.

The tissue web was formed on a forming fabric, vacuum dewatered to approximately 25 percent consistency and then subjected to rush transfer when transferred to the transfer fabric. The web was then transferred to a through-air drying fabric. Transfer to the through-air drying fabric was done using vacuum levels of about 10 inches of mercury at the transfer. The web was then dried to approximately 98 percent solids before winding.

A control softening composition was prepared by mixing a cationic softening compound with a small amount of water using a high shear mixer. After mixing, the polymeric polyhydroxy compound (Carbowax PEG 1,000 commercially available from Dow Chemical Company, Midland, Mich.) was added along with silicone, as specified in Table 1, followed by further high shear mixing. Viscosity was measured by Brookfield DV-II ultra-type (Brookfield Engineering Laboratories) at 25° C. and 60 rpm. The silicone was UTA6014 (Commercially available from Wacker Chemical Corp., Adrian, Mich.) and the cationic softening compound was CEQ90 (Commercially available from Sunjin Chemical Co. Ltd).

An inventive softening composition was prepared by mixing the polymeric polyhydroxy compound (Carbowax PEG 1,000 commercially available from Dow Chemical Company, Midland, Mich.), silicone (UTA6014, commercially available from Wacker Chemical Corp., Adrian, Mich.) and water, as specified in Table 1, using a high shear mixer. After mixing, the pH of the composition was adjusted from about 5.5 to about 6.0 and the composition was further diluted with water and mixed. Viscosity was measured by Brookfield DV-II ultra-type (Brookfield Engineering Laboratories) at 25° C. and 60 rpm.

TABLE 1

| | Control | Inventive |
|---|---|---|
| | Composition | Composition |
| Silicone (wt %) | 2 | 2 |
| Cationic Softener (wt %) | 14 | — |
| Glycerin | 6 | 6 |
| Nonionic Surfactant | 5 | 5 |
| PEG-1,000 (wt %) | 7 | 7 |
| Water (wt %) | 66 | 80 |
| Estimated % Solids | 34.4 | 20.4 |
| Initial viscosity (cPs) | 96 | 14 |

The base sheet webs were converted into bath tissue rolls. Specifically, the basesheet was calendered using a conventional polyurethane/steel calender system comprising a 40 P&J polyurethane roll on the air side of the sheet and a standard steel roll on the fabric side. The calendered web was then subjected to topical treatment with a softening composition. The softening compositions were applied by offset gravure printing. The add-on levels where controlled by reducing the speed of the gravure roll relative to the speed of the offset roll by 50%. The estimated add-on levels are reported in Table 2. The estimated add-ons are provided as both a wet weight basis and a dry weight percentage basis.

TABLE 2

| | Estimated Softening | Estimated Softening |
|---|---|---|
| | Composition Add-on (wet | Composition Add-on |
| Sample | grams per square meter) | (dry wt %) |
| Treated Control 1 | 5.86 | 1.66 |
| Treated Control 2 | 3.31 | 0.94 |
| Treated Inventive 1 | 4.66 | 0.94 |

The finished products were subjected to physical analysis, which is summarized in Table 3.

TABLE 3

| | GMT | CD Stretch | CD TEA | COF | |
|---|---|---|---|---|---|
| Sample | (g/3″) | (%) | (g*cm/cm²) | (g) | TS7 |
| Treated Control 1 | 935 | 10.1 | 5.38 | 179 | 10.2 |
| Treated Control 2 | 959 | 10.1 | 5.75 | 187 | 10.6 |
| Treated Inventive 1 | 917 | 9.8 | 5.50 | 207 | 10.4 |

While various softening compositions, and tissue webs and products treated therewith, have been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto and the following embodiments.

In a first embodiment the present invention provides a treated tissue product comprising a tissue web having a first surface and an opposed second surface, a softening composition disposed on the first or the second surface, the softening composition consisting essentially of a polymeric polyhydroxy compound or mixtures thereof, a polysiloxane, a surfactant, glycerin and water, the treated tissue product having a coefficient of friction (COF) less than about 300 g.

In a second embodiment the present invention provides the tissue product of the first wherein the polymeric polyhydroxy compound or mixtures thereof is a solid at 70° F. (21° C.).

In a third embodiment the present invention provides the tissue product of the first or the second embodiments wherein the polymeric polyhydroxy compound is selected from the group consisting of polyethylene glycols and polypropylene glycols having a molecular weight from about 1,000 to about 5,000 g/mol and mixtures thereof. In other embodiments the polymeric polyhydroxy compound is a mixture of a first polyethylene glycol having a molecular weight from about 300 to 800 g/mol and a second polyethylene glycol having a molecular weight from about 1,000 to 1,500 g/mol.

In a fourth embodiment the present invention provides the tissue product of any one of the first through third embodiments wherein the tissue product has a geometric mean tensile (GMT) strength from 500 to 1,200 g/3″ and a TS7 value less than 11.0. In certain preferred embodiments the foregoing tissue product may have a COF from 150 to 250 g.

In a fifth embodiment the present invention provides the tissue product of any one of the first through fourth embodiments wherein the polysiloxane is selected from the group consisting of an amino-functional polydialkylsiloxane, a polydialkylsiloxane, a polyetherpolydialkylsiloxane, an amino functional polyetherpolydialkylsiloxane copolymer, and mixtures thereof.

In a sixth embodiment the present invention provides the tissue product of any one of the first through fifth embodiments wherein the softening composition comprises from about 0.5 to about 5.0 dry weight percent (wt %), based upon the dry weight of the tissue product.

In a seventh embodiment the present invention provides the tissue product of any one of the first through sixth embodiments wherein the softening composition comprises from about 5 to about 20 wt % of the polymeric polyhydroxy compound and from about 2 to about 5 wt % of the polysiloxane.

In an eighth embodiment the present invention provides the tissue product of any one of the first through seventh embodiments wherein the softening composition comprises from about 50 to about 80 wt % water.

In a ninth embodiment the present invention provides the tissue product of any one of the first through eighth embodiments wherein the ratio of the polymeric polyhydroxy compound to the polysiloxane, on a weight basis, is from about 10:1 to about 5:1.

In a tenth embodiment the present invention provides the tissue product of any one of the first through ninth embodiments wherein the softening composition comprises from about 4 to about 10 wt % nonionic surfactant.

In an eleventh embodiment the present invention provides the tissue product of any one of the first through tenth embodiments wherein the softening composition comprises from about 5 to about 20 wt % glycerin.

In a twelfth embodiment the present invention provides the tissue product of any one of the first through eleventh embodiments wherein the softening composition further comprises one or more additives selected from opacifying agents, pH modifiers, dyes, fragrances, preservatives, humectants, and skin protectants.

In a thirteenth embodiment the present invention provides the tissue product of any one of the first through twelfth embodiments wherein the softening composition further comprises a skin protectant selected from the group consisting of allantoin, kaolin, zinc oxide, aloe vera, vitamin E, petrolatum, lanolin, and combinations thereof.

In a fourteenth embodiment the present invention provides the tissue product of any one of the first through thirteenth embodiments wherein the softening composition further comprises a preservative in an amount of from 0.05 to 5 wt %, such as from 0.05 to 2 wt %.

In a fifteenth embodiment the present invention provides the tissue product of any one of the first through fourteenth embodiments wherein the softening composition is substantially free from imidazolinium and quaternary ammonium compounds selected from the group consisting of amidoamine quaternary ammonium compounds, diamidoamine quaternary ammonium compounds, ester quaternary ammonium compounds, alkoxy alkyl quaternary ammonium compounds, benzyl quaternary ammonium compounds, and alkyl quaternary ammonium compounds.

In a sixteenth embodiment the present invention provides the tissue product of any one of the first through fifteenth embodiments wherein the tissue product comprises one or more CWP, CTAD or UCTAD tissue webs, or combinations thereof.

In a seventeenth embodiment the present invention provides the tissue product of any one of the first through sixteenth embodiments wherein the treated tissue web is a CWP, CTAD or UCTAD tissue web.

1. A treated tissue product comprising a tissue web having a first surface and an opposed second surface, and a softening composition disposed on the first or the second surface, the softening composition consisting of at least one polymeric polyhydroxy compound, at least one polysiloxane, at least one surfactant, glycerin and water, the treated tissue product having a coefficient of friction (COF) less than about 300 g.

2. The treated tissue product of claim 1, wherein the at least one polymeric polyhydroxy compound is a solid at 70° F. (21° C.).

3. The treated tissue product of claim 1, wherein at least one polymeric polyhydroxy compound is selected from the group consisting of polyethylene glycols and polypropylene glycols having a molecular weight from about 1,000 to about 5,000 g/mol.

4. The treated tissue product of claim 1, wherein the polymeric polyhydroxy compound is a mixture of a first polyethylene glycol having a molecular weight from about 300 to 800 g/mol and a second polyethylene glycol having a molecular weight from about 1,000 to 1,500 g/mol.

5. The treated tissue product of claim 1 having a COF from 150 to 250 g.

6. The treated tissue product of claim 1 having a geometric mean tensile (GMT) strength from about 500 to about 1,200 g/3″ and a TS7 value less than 11.0.

7. The treated tissue product of claim 1, wherein at least one polysiloxane is selected from the group consisting of an amino-functional polydialkylsiloxane, a polydialkylsiloxane, a polyetherpolydialkyl-siloxane, an amino functional polyetherpolydialkylsiloxane copolymer, and mixtures thereof.

8. The treated tissue product of claim 1, wherein the softening composition comprises from about 0.5 to about 5.0 dry weight percent (wt %), based upon the dry weight of the tissue product.

9. The treated tissue product of claim 1, wherein the softening composition comprises from about 5 to about 20 wt % of the polymeric polyhydroxy compound, and from about 2 to about 5 wt % of the polysiloxane.

10. The treated tissue product of claim 1, wherein the softening composition comprises from about 50 to about 80 wt % water.

11. The treated tissue product of claim 1, wherein the ratio of the polymeric polyhydroxy compound to the polysiloxane, on a weight basis, is from about 10:1 to about 5:1.

12. The treated tissue product of claim 1, wherein the surfactant is a nonionic surfactant and the softening composition comprises from about 4 to about 10 wt % of the surfactant.

13. The treated tissue product of claim 1, wherein the softening composition comprises from about 5 to about 20 wt % glycerin.

14. A treated tissue product comprising a tissue web having a first surface and an opposed second surface, a softening composition disposed on the first or the second surface, the softening composition consisting:
a. from about 5 to about 20 wt % of one or more polyethylene glycols, wherein the polyethylene glycol or mixtures thereof is a solid at 70° F. (21° C.);
b. from about 2 to about 5 wt % of a polysiloxane selected from the group consisting of an amino-functional polydialkylsiloxane, a polydialkylsiloxane, a polyetherpolydialkyl-siloxane, an amino functional polyetherpolydialkylsiloxane copolymer, and mixtures thereof;
c. from about 4 to about 10 wt % of a nonionic surfactant;
d. from about 5 to about 20% glycerin; and
e. water.
wherein the treated tissue product has a coefficient of friction (COF) less than about 300 g.

15. The treated tissue product of claim 14, wherein the tissue web is a through-air dried tissue web and the treated tissue product has a GMT from about 500 to about 1,500 g/3″, a Stiffness Index less than about 15 and a sheet bulk greater than about 10 cc/g.

16. The treated tissue product of claim 14, wherein the treated tissue product comprises from about 0.5 to about 5.0 wt % softening composition.

17. The treated tissue product of claim 14, wherein the polyethylene glycol has a molecular weight from about 1,000 to about 5,000 g/mol.

18. The treated tissue product of claim 14, wherein the softening composition comprises a first polyethylene glycol having a molecular weight from about 300 to 800 g/mol and a second polyethylene glycol having a molecular weight from about 1,000 to 1,500 g/mol.

19. The treated tissue product of claim 14, wherein the softening composition comprises from about 50 to about 80 wt % water and the ratio of the polyethylene glycol to the polysiloxane, on a weight basis, is from about 10:1 to about 5:1.

20. The treated tissue product of claim 14 having a geometric mean tensile (GMT) strength from 500 to 1,200 g/3″, a TS7 value less than 11.0 and a COF from 150 to 250 g.

21. A method of manufacturing a treated tissue product comprising the steps of:
a. providing an aqueous softening composition consisting of at least one polymeric polyhydroxy compound, at least one polysiloxane, at least one surfactant, glycerin and water;
b. providing a tissue web having a first and an opposed second surface; and
c. applying the aqueous softening composition to at least the first surface of the tissue web to produce a treated tissue product.

22. The method of claim 21, wherein step (c) is carried out by slot coating, gravure printing, flexographic printing or spraying the aqueous softening composition onto at least the first surface of the tissue web.

23. The method of claim 21, wherein step (c) is carried out at a temperature from about 20 to about 25° C.

24. The method of claim 21, wherein step (c) is carried out at a temperature of less than about 100° C. by slot coating, gravure printing, flexographic printing or spraying.

25. The method of claim 21, wherein the aqueous softening composition comprises from about 50 to about 80 wt % water and has a viscosity from about 10 to about 100 cPs.

26. The method of claim 21, wherein amount of aqueous softening composition applied to the first surface of the tissue web is from about 0.5 to about 5.0 dry wt %.

27. The method of claim 21, wherein the aqueous softening composition comprises from about 40 to about 90 wt % water.
